(19) United States
(12) Patent Application Publication
(10) Pub. No.: US 2014/0139999 A1
(43) Pub. Date: May 22, 2014

(54) PORTABLE COMPUTER WITH LATCH MECHANISM

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: BAO-QUAN SHI, Shenzhen (CN)

(21) Appl. No.: 13/947,383

(22) Filed: Jul. 22, 2013

(30) Foreign Application Priority Data
Nov. 19, 2012 (CN) 2012104673904

(51) Int. Cl. G06F 1/16

(52) U.S. Cl. CPC G06F 1/1633
USPC 361/679.55

(57) ABSTRACT

A portable computer includes a cover and a case. The cover includes a locking member which includes a locking pole. The locking pole includes a head portion. The locking pole defines a pair of cutouts adjacent the head portion. The case includes a clipping piece. The clipping piece includes a clipping portion. The clipping portion includes a surrounding portion and a pair of restricting portions connected to opposite ends of the surrounding portion. The surrounding portion surrounds a receiving space. The head portion is inserted into the receiving space by elastically deforming the pair of restricting portions. The clipping piece maintains the head portion in the receiving space by the pair of restricting portions rebounding to be located in the pair of cutouts.

### BACKGROUND

1. Technical Field

The present disclosure generally relates to a portable computer, and particularly to a portable computer including a latch mechanism.

2. Description of Related Art

Portable computers, such as laptop computers and notebook computers, have become increasingly popular for general use. Generally, a portable computer includes a cover unit and a base unit pivotally connected with the cover unit, and the cover unit is folded onto the base unit to cover the base unit when the portable computer is not in use. A latch mechanism is provided to lock the cover unit to the base unit. However, a conventional latch mechanism has several components and complex structures, which may be easily damaged.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a portable computer with a latch mechanism according to one embodiment.

FIG. 2 is an enlarged view of an encircled portion II of FIG. 1.

FIG. 3 is an exploded, isometric view of a case and a clipping piece of the portable computer of FIG. 1.

FIG. 4 is an assembled view of the portable computer of FIG. 1.

FIG. 5 is another assembled view of the portable computer of FIG. 1.

FIG. 6 is a sectional view in an enlarged scale taken along line VI-VI of FIG. 5.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

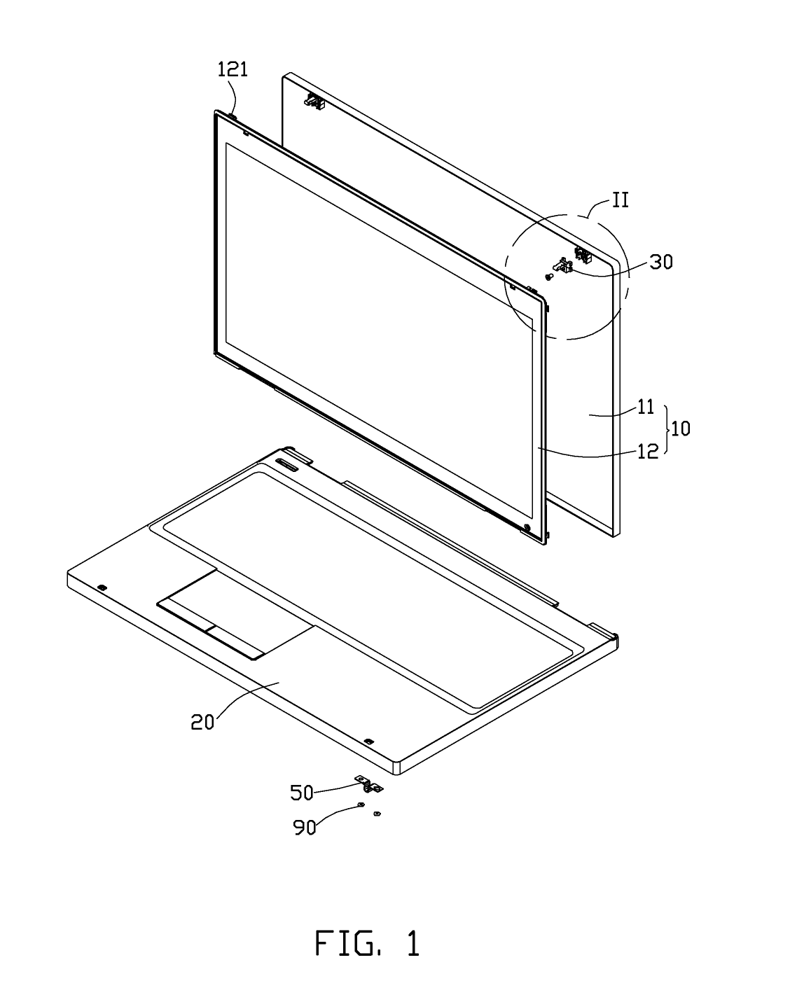

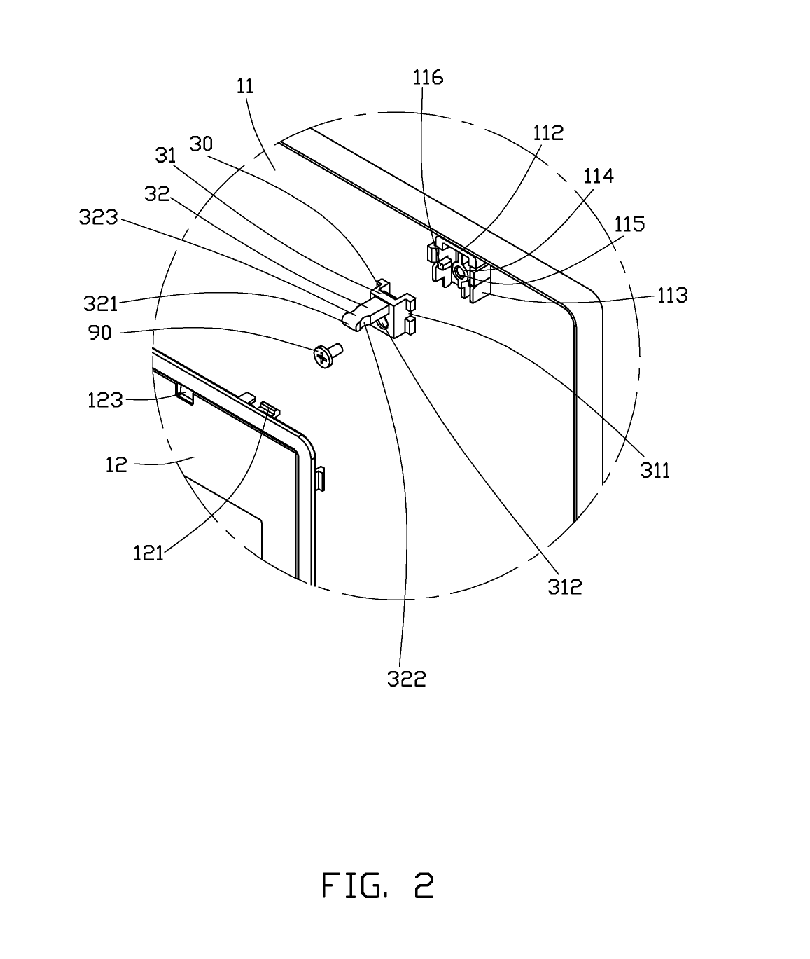

FIGS. 1 and 2 show an embodiment of a portable computer with latch mechanism. The portable computer includes a cover 10, a case 20, a pair of locking members 30, and a pair of elastic clipping pieces 50. The pair of locking members 30 is configured to be mounted on the cover 10, and the pair of clipping pieces 50 is configured to be mounted on the case 20.

The cover 10 includes a plate 11 and a frame 12. The plate 11 includes a pair of mounting bases 112. Each mounting base 112 includes a pair of parallel side walls 113. The pair of side walls 113 is perpendicularly connected to the plate 11. The plate 11 includes a post 114 which is located between the pair of side walls 113. A securing hole 115 is defined in the post 114. The pair of side walls respectively forms a positioning block 116 extending in toward each other. A plurality of clasps 121 is formed on edges of the frame 12. The frame 12 defines a pair of openings 123 corresponding to the pair of mounting bases 112 of the plate 11.

The locking member 30 includes a securing portion 31 and a locking pole 32. The securing portion 31 is formed in an “n” shape. The securing portion 31 defines a pair of positioning slots 311 corresponding to the pair of positioning blocks 116 of the plate 11. The securing portion 31 defines a through hole 312. The locking pole 32 is connected on the securing portion 31. The locking pole 32 includes a head portion 321. The locking pole 32 defines a pair of cutout 322 to form a narrow portion 323 adjacent the head portion 321. A width of the head portion 321 is greater than that of the narrow portion 323.

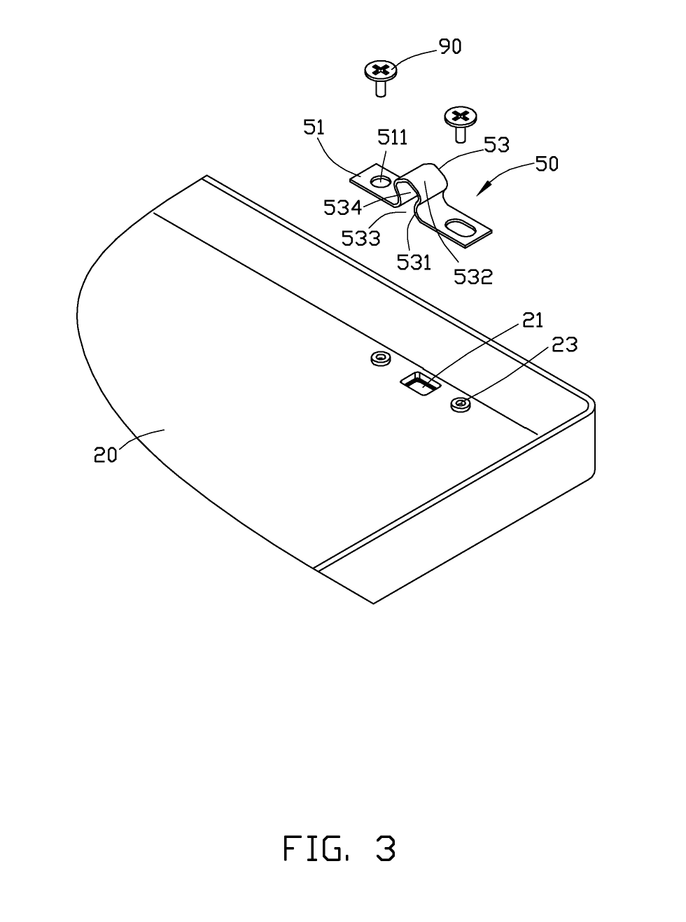

Referring to FIGS. 1 and 3, the case 20 defines a pair of inserting holes 21 corresponding to the pair of openings 123 of the frame 12. The case 20 further defines a pair of locking holes 23 adjacent each of the pair of inserting holes 21. The clipping piece 50 includes a pair of securing feet 51 and a protruded clipping portion 53 connected between the pair of securing feet 51. Each securing foot 51 defines a mounting hole 511. The clipping portion 53 includes a pair of restricting portions 531 and a surrounding portion 532 which is connected between the pair of restricting portion 531. The pair of restricting portions 531 is connected to the pair of securing feet 51. A distance between the pair of restricting portions 531 is small to form a restricting groove 533 therebetween. The surrounding portion 532 surrounds a receiving space 534 therein. The receiving space 534 is in communication with the restricting groove 533.

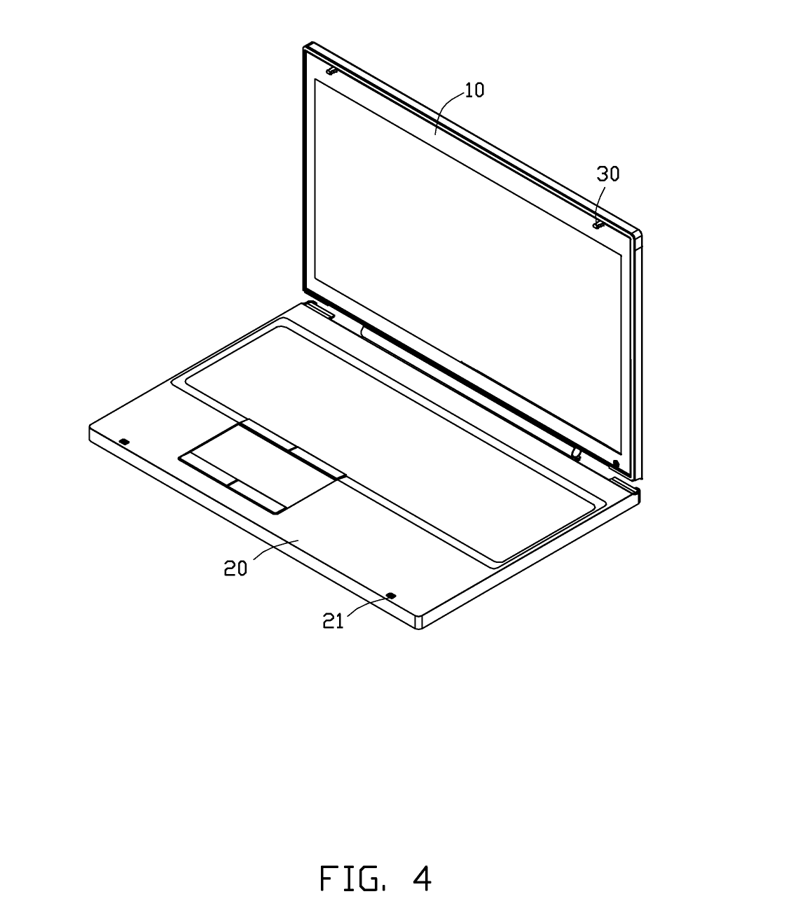

Referring to FIGS. 1 to 4, in assembly, the securing portion 31 of the locking member 30 is positioned in the mounting base 112. The positioning blocks are inserted in the positioning slots 311. At this position, the through hole 312 is aligned to the securing hole 115. A fastener 90 is secured in the through hole 312 and the securing hole 115 to secure the locking member 30 on the plate 11. Then, the locking pole 32 of the locking member 30 is inserted in the opening 123 of the frame 12. The clasps 121 of the frame 12 engage on the plate 11 to mount the plate 11 and the frame 12 together.

In succession, the locking holes 23 of the case 20 are aligned to the mounting holes 511 of the clipping piece 50. Two fasteners 90 are secured in the locking holes 23 and the mounting holes 511 to secure the clipping piece 50 on the case 20. At this position, the restricting groove 533 of the clipping piece 50 is aligned to the inserting hole 21.

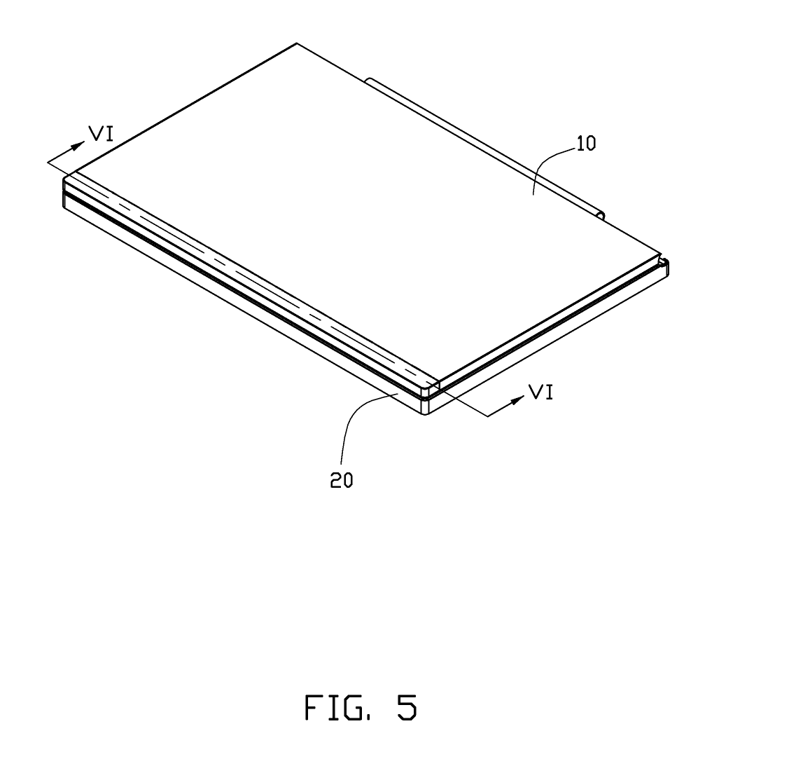

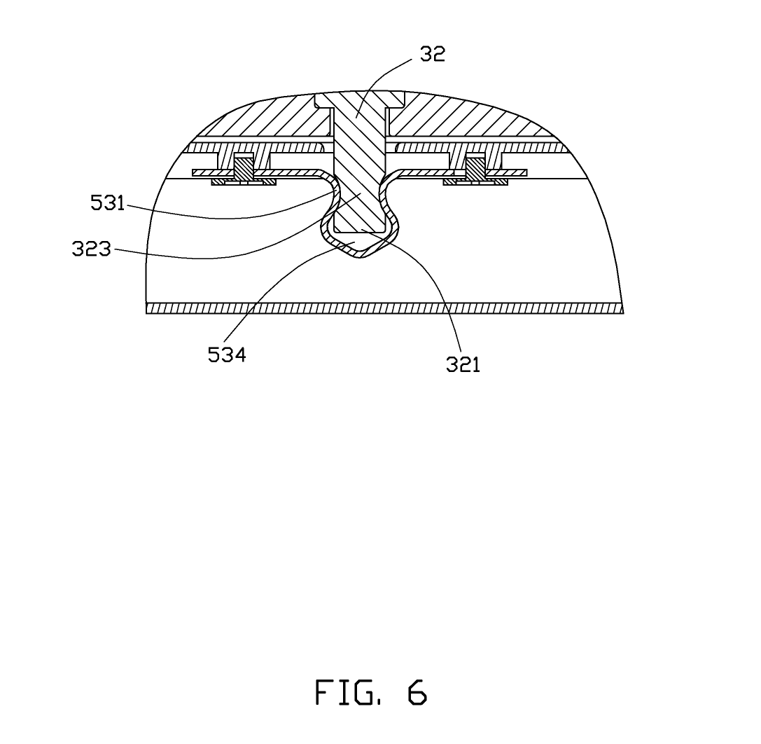

Referring to FIGS. 5 and 6, in use, the cover 10 is moved towards the case 20. The locking pole 32 is inserted in the inserting hole 21. The head portion 321 of the locking pole 32 abuts the pair of restricting portions 531 and elastically deforms the pair of restricting portions 531. The cover 10 continues to move to have the head portion 321 slide over the restricting portions 531. At this position, the head portion 321 is located in the receiving space 534. The restricting portions 531 are aligned to the cutouts 322 of the locking pole 32. The restricting portions 531 rebounds to be located in the cutouts 322 to maintain the held portion 321 in the receiving space 534. Thereby, the cover 10 is latched to the case 20 by the engagement of the locking pole 32 and the clipping piece 50.

To detach the cover 10 from the case 20, the head portion 321 of the locking pole 32 is moved out of the receiving space 534 through the restricting groove 533 by elastically deforming the pair of restricting portions 531 of the clipping piece 50.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A portable computer, comprising:
a cover comprising a locking member attached thereon, the locking member comprising a locking pole which comprises a head portion, the locking pole defining a pair of cutouts adjacent the head portion; and
a case comprising a clipping piece attached thereon, the clipping piece comprising a clipping portion, the clipping portion comprises a surrounding portion and a pair of restricting portions connected to opposite ends of the surrounding portion, the surrounding portion surrounding a receiving space;
wherein the head portion is configured to be inserted into the receiving space by elastically deforming the pair of restricting portions, and the clipping piece is configured to maintain the head portion in the receiving space by the pair of restricting portions rebounding to be located in the pair of cutouts.

2. The portable computer of claim 1, wherein the clipping piece further comprises a pair of securing feet connected to the pair of restricting portions, and the pair of securing feet is secured on the case.

3. The portable computer of claim 2, wherein the pair of securing feet defines two mounting holes, and the case defines two locking holes, and two fasteners are mounted in the two mounting holes and the two locking holes to mount the clipping piece on the case.

4. The portable computer of claim 1, wherein the case defines an inserting hole which is aligned to the receiving space, and the head portion is inserted in the receiving space through the inserting hole.

5. The portable computer of claim 1, wherein the cover comprises a plate and a frame, the frame comprises a plurality of clasps, and the plurality of clasps is engaged on the plate to mount the plate and the frame together.

6. The portable computer of claim 5, wherein the plate comprises a mounting base, the mounting base comprises a pair of positioning blocks, the locking member comprises a securing portion, the securing portion defines a pair of positioning slots, and the securing portion is located in the mounting base with the pair of positioning blocks inserted into the pair of positioning slots.

7. The portable computer of claim 6, wherein the mounting base defines a securing hole which is located between the pair of positioning blocks, the securing portion of the locking member defines a through hole, and a fastener is secured in the through hole and the securing hole to mount the locking member on the mounting base.

8. The portable computer of claim 7, wherein the frame defines an opening, and the locking pole of the locking member is inserted in the receiving space through the opening.

9. A portable computer, comprising:
a cover comprising a locking pole, the locking pole comprising a head portion at a distal of the locking pole, the locking pole comprising a narrow portion adjacent the head portion, a width of the narrow portion being smaller than a width of the head portion;
a case comprising a clipping portion, the clipping portion comprising a surrounding portion which surrounds a receiving space, a pair of restricting portion connected to opposite ends of the surrounding portion to form a restricting groove in communication with the receiving space, a width of the restricting groove being smaller than the wide of the head portion;
wherein the head portion is configured to be inserted into the receiving space through the restricting groove by elastically deforming the pair of restricting portions, and the clipping portion is configured to maintain the head portion in the receiving space by the pair of restricting portions rebounding to engage the narrow portion.

10. The portable computer of claim 9, wherein the clipping portion is formed on a clipping piece, the clipping piece comprises a pair of securing feet connected to the pair of restricting portions, and the pair of securing feet is secured on the case.

11. The portable computer of claim 10, wherein the pair of securing feet defines two mounting holes, and the case defines two locking holes, and two fasteners are mounted in the two mounting holes and the two locking holes to mount the clipping piece on the case.

12. The portable computer of claim 9, wherein the case defines an inserting hole which is aligned to the restricting groove, and the head portion is inserted in the receiving space through the inserting hole.

13. The portable computer of claim 9, wherein the cover comprises a plate and a frame, the frame comprises a plurality of clasps, and the plurality of clasps is engaged on the plate to mount the plate and the frame together.

14. The portable computer of claim 13, wherein the plate comprises a mounting base, the mounting base comprises a pair of positioning blocks, the locking pole is connected to a securing portion, the securing portion defines a pair of positioning slots, and the securing portion is located in the mounting base with the pair of positioning blocks inserted into the pair of positioning slots.

15. The portable computer of claim 14, wherein the mounting base defines a securing hole which is located between the pair of positioning blocks, the securing portion of the locking member defines a through hole, and a fastener is secured in the through hole and the securing hole to mount the locking member on the mounting base.

16. The portable computer of claim 15, wherein the frame defines an opening, and the locking pole of the locking member is inserted in the receiving space through the opening.
